(19) United States
(12) Patent Application Publication
(10) Pub. No.: US 2023/0244187 A1
(43) Pub. Date: Aug. 3, 2023

(54) TIMEPIECE COMPRISING AZAN ANALOG COUNTER

(71) Applicant: ALFAJR TRADING EST, Khobar (SA)

(72) Inventor: Sulaiman A ALBASSAM, Khobar (SA)

(21) Appl. No.: 18/003,436

(22) PCT Filed: May 6, 2021
(86) PCT No.: PCT/IB2021/053878

§ 371 Date: Dec. 27, 2022

Related U.S. Application Data
(60) Provisional application No. 63/089,194, filed on Oct. 8, 2020.

(51) Int. Cl. G04B 19/23; G04C 23/50; G04C 23/44

(52) U.S. Cl. CPC G04B 19/23; G04C 23/44; G04C 23/50

(57) ABSTRACT

A timepiece, such as a clock or watch, that displays the current time and an analog Azan counter is disclosed. The timepiece comprises at least one device or mechanism to calculate the five (5) azan times based on at least one factor selected from the sun position, longitude and latitude position, time zone, DST system, and day of the year. The Azan analog counter may be attached to at least one device and implemented as an analog hand in the timepiece. A method of identifying and displaying a current time and an analog Azan counter on a timepiece is also disclosed.

### CROSS-REFERENCE TO RELATED APPLICATION

This application claims the benefit of priority to Provisional Application No. 63/089,194, filed Oct. 8, 2020, the entire contents of which are expressly incorporated herein by reference.

### TECHNICAL FIELD

The present disclosure relates generally to a timepiece, such as a clock or watch, that determines and indicates the time for the Islamic Prayer Call (“Azan”) by using a “programmed hand” as an azan analog counter. The present disclosure also relates to analog watches and clocks comprising the disclosed azan analog counter.

### BACKGROUND

The Five Pillars of Islam are presented in the Qur’an as a framework for worship and a sign of commitment to the faith. In addition to faith, alms, fasting and pilgrimage, one pillar requires performance of five daily prayers. The prayers are to be performed at specific times that vary throughout the year depending on the rising and setting of the sun, which depends upon the date and geographical location. Each prayer is performed facing Mecca and consists of the repetition of actions and words.

To ensure this important pillar of Islam is maintained, a device is needed to aid Muslims around the world in performing the five daily prayers, specifically providing a countdown in advance of the time to pray. This is especially important for Muslims who engage in international travel and need a timepiece that updates automatically to provide an accurate countdown to Azan based on the geographical location of the wearer. In this disclosure, there is provided an analog count-up and count-down timer to Azan which uses a watch/clock hand.

### SUMMARY

In one embodiment, there is described a timepiece displaying a current time and an analog Azan counter, comprising: at least one device to calculate the five (5) azan times based on at least one factor selected from the sun position, longitude and latitude position, and day of the year; and an Azan analog counter attached to at least one device and implemented as a hand in the timepiece. In an embodiment, the timepiece comprises an analog watch or clock or has the appearance of an analog watch or clock.

It is envisioned that the Azan analog counter described herein is implemented in watches or clocks using a normal second hand. However, in an embodiment, the Azan analog counter may also be implemented in watches and clocks as a separate and distinct hand from the normal second hand.

In an embodiment, the Azan analog counter is implemented with a hidden display. For example, in this embodiment the timepiece comprises a smart watch, a hybrid watch, a smart clock, or a hybrid clock.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIGS. 1A, 1B, 1C, 1D and 1E are clock views of “Azan analog counter” position according to different times, where the geographical located is based on Riyadh, Saudi Arabia on 16 Sep. 2020 and current azan is Dhuhr azan, which is at 11:48 AM.

FIG. 1F is the same clock of FIGS. 1A, 1B, 1C, 1D and 1E but which show the time is past 30 minutes after Dhuhr azan, and next azan (Asr) which is showing 3:16, with Azan analog counter on OFF position.

FIGS. 2A, 2B and 2C are views of an Islamic watch having an analog design, according to the embodiment shown in FIG. 1C.

FIG. 3 is a schematic showing a system according to the present disclosure in which hands and Azan index of a timepiece that will automatically be adjusted based on location.

FIG. 4 is a flow diagram exemplifying the method of the operation according to the system that is described in FIG. 3 with MCU, user interface, and analog movements.

### DETAILED DESCRIPTION

As used herein, “Azan” is defined as the Islamic Prayer Call, typically, but not required to be recited by a muezzin from a mosque. In different contexts, the word “Azan” to means the “current azan time”.

As used herein, “timepiece” is meant to include both a stand-alone device, such as a clock and a portable device intended to be carried or worn by a person, such as a watch.

As used herein, “normal second hand” refers to the hand that moves around the fastest on an Analog Clock. It shows the number of seconds. In some embodiments, it can also be used as the Azan analog counter. In other embodiments, the Azan analog counter is implemented as a separate and distinct hand from the normal second hand.

As used herein, “azan taqweem system” is the publicly available system that provide Azan times for a particular location, such as a particular country in which the disclosed timepiece is located.

Muslims pray five times a day, with their prayers being known as Fajr (dawn), Dhuhr (midday), Asr (afternoon), Maghrib (sunset), and Isha (nighttime). The timepiece described herein provides an Azan analog counter for each of these prayers.

As used herein, “a balanced interval of time” means that the minutes before and after the current Azan are the same. Non-limiting examples of a balanced interval of time, are -30 to +30 minutes from the current Azan, or an interval other than 30 minutes, such as -15 to +15 minutes, or -59 to +59 minutes.

As used herein, “a non-balanced interval of time” means that the time before and after the current Azan are not the same. A non-limiting example of a non-balanced interval of time is -29 to +59 minutes.

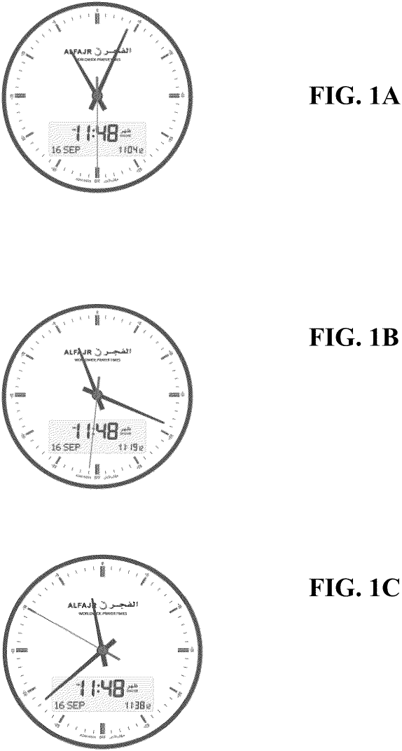

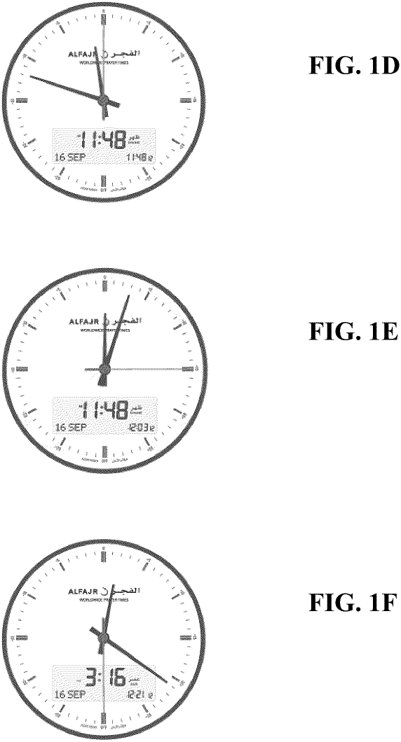

As used herein, “current azan” means the closest azan time that is within the predetermined interval. So, it is possible that current time has already passed the “current azan” time. For example, in FIG. 1E the current azan is at 11:48AM and current time is 12:03PM

The Azan analog counter described herein uses predetermined interval before azan and a predetermined interval after azan. It is possible to use balanced predetermined intervals where both intervals are the same, or non- balanced predetermined intervals when the two intervals are different.

The examples below assume a balanced interval of 29 minutes, i.e. start count-down from (-29) minutes before current azan, up to (29) minutes after the current azan. In these examples, position 30 is used to indicate non-active. Certain embodiments of the disclosure are best described with reference to the figures.

For example, FIG. 1A shows a current time of 11:04 AM, which is 38 minutes before Azan. In this embodiment, the Azan index hand at position 30, which implies a non-active counter. The reason no counting is occurring because Azan is more than 29 minutes away. It is assumed that in FIGS. 1A-1E, the timepieces reflect 11:48 AM Dhuhr azan at Riyadh city, KSA on 16 Sep. 2020.

FIG. 1B shows a current time of 11:19 AM is shown, which is 29 minutes before Azan. Accordingly, this figure shows the Azan index hand at position 29, reflecting the number of minutes to Azan.

FIG. 1C shows a current time of 11:38 AM is shown, which is 10 minutes before Azan. Accordingly, this figure shows the Azan index hand at position 10, reflecting the number of minutes to Azan.

FIG. 1D shows a current time of 11:48 AM is shown, which is exactly Azan. Accordingly, this figure shows the Azan index hand at position 0, reflecting Azan.

FIG. 1E shows a current time of 12:03 PM is shown, which is 15 minutes after Azan. Accordingly, this figure shows the Azan index hand at position 15, reflecting the number of minutes to Azan.

FIG. 1F shows a current time of 12:21 PM, which is 33 minutes after Azan. As a result, the Azan index hand is at position 30 to reflect that no counting is occurring. As the current time in this example (12:21 PM) is not within 29 minutes before or after any azan, the Azan analog counter is at off position.

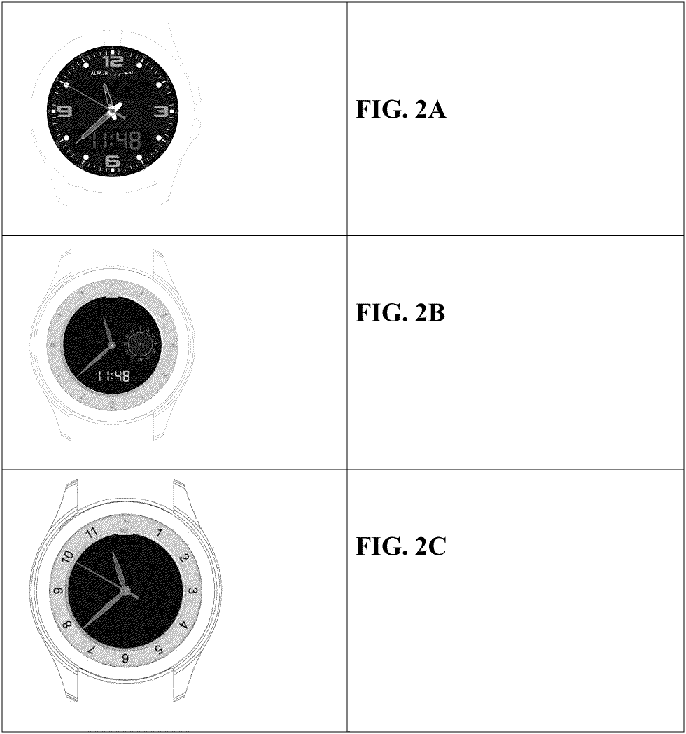

FIGS. 2A-2C are views of an Islamic watches with analog design, with same information as the embodiment shown in FIG. 1C, e.g., a current time of 11:38 AM, which is assumed to be 10 minutes before Azan. In one embodiment, represented by FIG. 2A shows an Azan analog counter implemented in watches using normal second hand.

In another embodiment, FIG. 2B shows an Azan analog counter is implemented using a separate special hand.

In yet another embodiment, FIG. 2C shows an Azan analog counter implemented with a hidden display. This embodiment can be used in smart watches or hybrid watches or clocks to give a complete analog feel and look.

### Timepiece Implementations

The Azan counter idea can also be implemented in wrist watches and with different options. Non-limiting examples of such implementations are provided below.

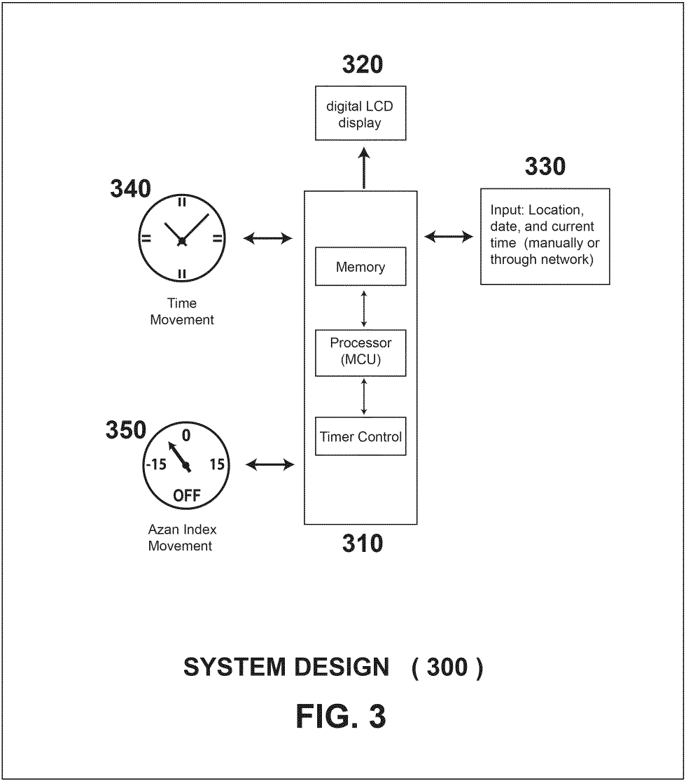

As described herein, there is described a system that includes analog movement with hands position detection. The movement can automatically detect the position of the hands. For example, in one embodiment, this can be done using small LED sensor in the movement, or a mechanical device or mechanism. While it is understood that there can be one or more movements in this system, there must be an independent motor to control the Azan counter hand. In other words, the time keeping movement may have one or more motors to control the hour and minutes hands; and possibly the seconds hands, as long as there is an independent motor for the Azan counter hand. Thus, there can be physically one movement with at least two motors, that can control the Azan index hand, and possibly two or three hands. FIG. 3 show more details of MCU signals control to movement hands, to keep correct time and correct Azan index position.

In another embodiment, there is described a system that includes analog movement without position detection. In this embodiment, position detection is set [once] by the user before using the clock/watch. In this embodiment, the movements structures are similar to those described above, except that one or more movement(s) do not have position detection device or mechanism. In this case, the hands positions are set [once] by the user before using the clock/watch, and the MCU control thereafter is same as above.

A more detailed description of embodiments according to the present disclosure, specifically with hands that will automatically be re-adjusted with hand position detection and without hand position detection, is provided in FIG. 3. In the embodiment shown in FIG. 3, the system 300 comprises processor, which comprises a microcontroller unit (MCU), memory, and time keeping device or mechanism 310 that is in communication with digital liquid crystal display (LCD) 320, and possible input pushers 330.

FIG. 3 further shows the output from the processor or microcontroller unit 310, which may include time movement 340, with two or more hands, Azan Index (AI) movement 350, with one hand, or a combination thereof.

In one embodiment, the input 330 to the microcontroller unit 310 (location, date, time) is done once and whenever the location is changed. The input can be done manually by press pushers on the timepiece 330 or using network communication.

In one embodiment, the time movement 340 and Azan index movement 350 are driven by pulses from the microcontroller unit interface 310. In one embodiment, the two movements can have position sensors, which can also communicate with the microcontroller unit.

In an alternative embodiment, the time movement 340 and Azan index movement 350 can be without position sensor, in which case the wearer or operator of the timepiece would need to initially set the correct positions manually. In this embodiment, the timepiece would need to be set once during startup.

In an embodiment, manually setting the correct positions of the time movement 340 and Azan index movement 350 can be performed either mechanically, such as by using the crown or digitally using the microcontroller unit through the pusher interface or thru network communication.

In one embodiment, the time movement 340 and Azan index movement 350 are independent. It is possible, for example, that the time movement 340 can have two or more hands, whereas the Azan index movement 350 will have exactly one hand, which will indicate Azan Counter position.

In one embodiment, the microcontroller unit will keep the correct time and date and will re-calculate Azan times daily at a pre-defined time, such as at midnight. The microcontroller unit will keep the analog time movement 340 synchronized with current digital time and will also adjust the Azan index movement 350 hand position depending on current time and current azan time. The Azan index hand position indicates the number of minutes remaining to (or after) the current Azan, as described herein.

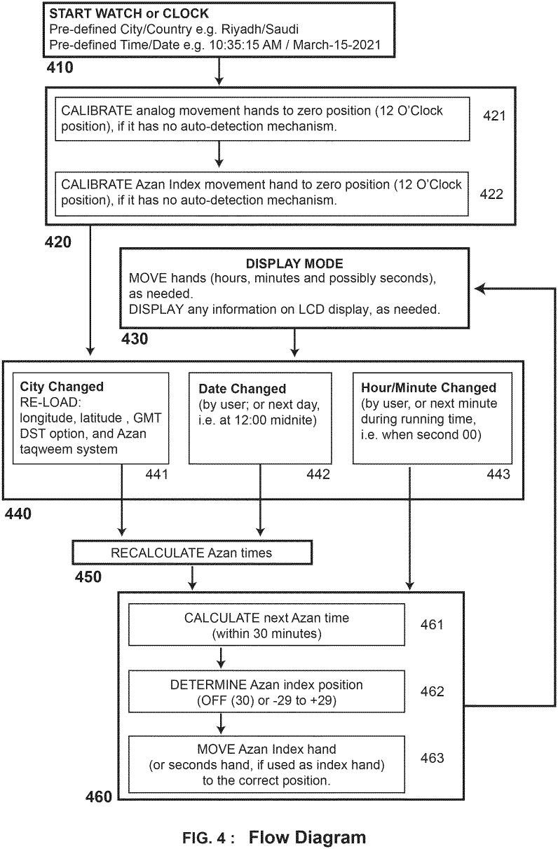

Additional description of embodiments according to the present disclosure, specifically related to the operation of the disclosed watch or clock, is provided in the flow diagram of FIG. 4. The flow diagram is based on the system that is described in FIG. 3 with MCU, user interface, and analog movements.

With regard to the actual operation, after watch or clock startup 410, it assumes a default time, and default city. The default city includes its information about that city, including: longitude and latitude coordinates, time zone (relative to GMT), daylight savings time (DST) option (ON, OFF, or Auto-DST), and the most widely azan taqweem system used at this country. For example, the default city can be Riyadh, Saudi Arabia with the following characteristics:
Longitude: 24° 46′ 27″ N
Latitude: 46° 44′ 19″ E
Time zone: GMT+3
DST option: OFF
Azan Taqweem: Um Alqura System

The above information (in addition to current date) is used by the MCU processor (as shown in FIG. 3), to calculate the Azan times for this location. In an embodiment, one time movement calibrations are required. These are shown in step 420 of FIG. 4. In some embodiments, movements have position-detection device or mechanism, and this step is done automatically after startup. Otherwise, the user would need to adjust the movement hands and Azan Index movement hand manually. This can be done through the regular crown associated with an analog timepiece. This may also be done using an electronic crown (or E-crown). Alternatively, this may be done through a network.

Again, with reference to the flow-diagram of FIG. 4, step 430 shows the normal/running display of the device. In normal operation, the device will show the Azan index hand in the correct position (relative to current time and azan time). During operation of an embodiment of the present disclosure, the MCU will move time movement hands (minutes and hours and possibly seconds), as needed. Hands rotation intervals depend on the gear ratios of each hand in the underlying movement(s). For example, in this embodiment, the minute hand will move one-tic every 10 seconds and hour hand will move one-tic every 2 minutes and the second hand (when used) will move one tic per second. It is possible that the device comprises an electronic display (such as an LCD, LED, or otherwise), which shows the digital time, date, or other information. In one embodiment, the display can be turned off completely, to give analog feeling of the device.

The MCU control will move to 440, if the MCU detects any change in city, date, or time (hours or minutes). Specific reference is made to the various contingencies and embodiments within step 440. For example, in 441, when a city is changed (by the user, or during initial startup), the MCU will reload all information that is needed to calculate azan times during the year and the MCU will transfer control to step 450.

Step 442 shows the contingency when the date has changed (by the user, or at midnight) to go to next date and the MCU will transfer control to step 450.

Step 443 shows the contingency when time (hour or minute) has changed (by the user, or when seconds become 00). In this embodiment, the MCU will transfer control to step 460, as there is no need to recalculate azan time.

It is noted that a time change from 11:59:59 PM to 12:00:00 AM (with date change), is handled in step 442. In this embodiment, the Azan time and Azan index calculations are based on full minutes, e.g. seconds is equal 00 (at the Azan time). The same idea can be extended to use Azan times with seconds, but it is not necessary for this embodiment.

Step 450 is where the MCU will recalculate new Azan times, based on Date, and city information as given in 440. Non-limiting examples of the variables that go into the recalculation of new Azan times include, Longitude and Latitude coordinates, Time Zone, Daylight Savings Times (DST) option, and Azan Taqweem system. The azan times are calculated based on the Sun position in the sky, relative to the location on Earth.

Azan times in Muslim world are normally calculated based on the Sun angle (relative to the Horizon). Different Azan calculation systems (called Taqweem systems) are used in different countries. Some taqweem, like Um Alqura in Saudi Arabia, use as fixed time interval to calculate Isha azan, which is calculated as one hour and thirty minutes after Magrib Azan each day. As one skilled in the art would appreciate, Magrib Azan is equal to Sunset time at the selected location. The position of the Sun in the sky, can be calculated given the date and time. Alternatively, it can be tabulated.

Similarly, the Azan times can be tabulated for some locations of the world or can be calculated daily. Calculating Azan times is often more popular than tabulation, as one can more accurately calculate Azan times all over the world.

In our embodiment, we use Sun position calculation for better accuracy, and allow user to use position coordinates of the location, in case it falls in a remote or rural area.

Finally, step 460 in FIG. 4 determines the next Azan. For example, step 461 shows the MCU will determine the next Azan depending on current time. In this step, if 30 minutes has passed after the “current azan”, the current azan will be changed to the to the next azan.

In step 462, depending on current time and current azan, MCU will calculate the Azan Index position. In this step, if Azan time is not within + / - 30 minutes from current time, the index is assumed at 30 (OFF). In another embodiments, other time intervals can be used, for example +/- 59 minutes after/from azan time, and use 60 position to be OFF, provided the Azan index movement can support 120 positions (or tics).

In step 463, the MCU will move the Azan Index hand (or the second hand, if used as an Azan Index hand) to the correct position. In one embodiment during normal operation, the Azan Index hand will move one-tic to next position or stay in position.

In another embodiment, the Azan Index hand can have two alternating functions depending on the current time and azan time. When the current time is within +/- 30 minutes of the current Azan, the hand will function as Azan index, and otherwise will function as normal running seconds. In this embodiment there is no OFF position for the Azan Index hand.

In an embodiment, the timepiece described herein may reflect Azan intervals other than 30 minutes. For example, the interval can be -59 to +59 minutes to activate Azan index operation or can be -15 to +15 minutes or any number in between. Moreover, the Azan (negative and positive) intervals can be non-balanced. For example, in one embodiment, the Azan intervals can be -29 to +59 minutes. The foregoing are non-limiting examples of both balanced and non-balanced Azan intervals. It is appreciated that various other intervals are possible.

In one embodiment, there further comprises an additional device or mechanism or system that points to the direction of Makkah. For example, the device or mechanism or system comprises a digital compass sensor, which directs an analog hand to point to Makkah (or North).

As the actual time of praying, changes from one mosque to another and from place to place (and in addition to different taqweem systems), the disclosed device is configured to be adjusted by a fixed time interval after each azan. In one embodiment, the disclosed watch or clock is further configured to give a reminder, such as a beep or alarm as reminder for actual prayer.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure.

Other embodiments of the invention will be apparent to those skilled in the art from consideration of the specification and practice of the invention disclosed herein. It is intended that the specification and examples be considered as exemplary only, with the true scope of the invention being indicated by the following claims.

What is claimed is:

1. A timepiece displaying a current time and an Azan analog counter, comprising:
at least one device to calculate the five (5) azan times based on at least one factor selected from the sun position, longitude and latitude position, and day of the year; and
an Azan analog counter attached to said at least one device and implemented as a hand in said timepiece, wherein the Azan index hand position indicates the number of minutes remaining to (or after) the current Azan.

2. The timepiece of claim 1, which is a watch or clock, having the appearance of an analog watch or clock.

3. The timepiece of claim 1, wherein the Azan analog counter is implemented in watches and clocks as an Azan Index hand using a normal second hand or a separate and distinct hand from the normal second hand.

4. The timepiece of claim 3, wherein the Azan Index hand has two alternating functions which differ based on the current time and azan time.

5. The timepiece of claim 4, wherein the Azan Index hand changes its function to a normal second hand when the current time is not within the predetermined time of the current Azan.

6. The timepiece of claim 5, wherein the Azan index predetermined time interval is chosen from a balanced or a non-balanced interval of time.

7. The timepiece of claim 6, wherein the Azan index predetermined time interval is chosen from a balanced interval of time from -29 to +29 minutes relative to current Azan.

8. The timepiece of claim 6, wherein the Azan index predetermined time interval is chosen from a non-balanced interval from -29 minutes before current azan up to +59 minutes after current Azan.

9. The timepiece of claim 1, wherein the Azan analog counter is implemented with a hidden display.

10. The timepiece of claim 1, wherein the timepiece comprises a microcontroller unit.

11. The timepiece of claim 10, wherein the microcontroller unit comprises a movement device with three or more hands, wherein one hand shows Azan Index (AI) movement.

12. The timepiece of claim 11, wherein the microcontroller unit comprises an input to manually enter at least variable chosen from location, date, or time.

13. The timepiece of claim 12, wherein the timepiece comprises a time movement and an Azan index movement, which are driven by a pulse from the microcontroller unit and move independent of each other.

14. The timepiece of claim 13, wherein the time movement and Azan index movement further comprises position sensors which communicate with the microcontroller unit.

15. The timepiece of claim 13, wherein the time movement and Azan index movement do not comprise position sensors but comprise a device for mechanically setting up the timepiece, wherein said device comprises a crown or microcontroller unit configured to through the pusher interface.

16. The timepiece of claim 10, wherein the microcontroller unit is configured to keep the correct time and date and will re-calculate Azan times daily at a pre-defined time.

17. The timepiece of claim 10, wherein the microcontroller unit is configured to keep the analog time movement synchronized with current digital time and will also adjust the Azan index movement hand position depending on current time and current azan time.

18. The timepiece of claim 10, wherein the microcontroller unit is configured to recalculate new Azan times, based on one or more variables chosen from longitude and latitude coordinates, Time Zone, Daylight Savings Times (DST) option, and Azan Taqweem system.

19. The timepiece of claim 18, wherein the Azan Taqweem system comprises Um Alqura in Saudi Arabia.

20. The timepiece of claim 1, wherein the timepiece comprises a hybrid watch or a hybrid clock.

21. The timepiece of claim 1, wherein the timepiece comprises a smart watch or smart clock, with Azan Index hand displayed graphically on a digital display, without using any movement.

22. A method of identifying and displaying a current time and an analog Azan counter on a timepiece, the method comprising:
configuring a microcontroller unit to keep the analog time movement synchronized with current digital time and adjusting the Azan index movement hand position based on the current time and current azan time,
wherein the microcontroller unit is configured to recalculate new Azan times, based on one or more variables chosen from longitude and latitude coordinates, Time Zone, Daylight Savings Times (DST) option, and Azan Taqweem system.
